(19) United States
(12) Patent Application Publication
(10) Pub. No.: US 2013/0206508 A1
(43) Pub. Date: Aug. 15, 2013

(54) Holder assembly and a lift

(71) Applicant: Mark Micharl Rushlow, Livonia, MI (US)

(72) Inventor: Mark Micharl Rushlow, Livonia, MI (US)

(21) Appl. No.: 13/385,324

(22) Filed: Feb. 14, 2012

(51) Int. Cl. F16M 13/02; E04G 5/14; B66F 11/04; B65D 25/22

(52) U.S. Cl. 182/113; 206/557; 248/200

(57) ABSTRACT

A lift assembly 10 having a holder assembly 12 which is selectively and securely and removably coupled to the lift 10 and which provides desired storage of items needed by a user 16 of the lift assembly 10.

### GENERAL BACKGROUND

### Field of the Invention

The present invention generally relates to a holder assembly and to a lift and, more particularly, to a holder assembly which selectively, removably and securely allows items to be stored and retrieved within a lift assembly and to a lift assembly having such a new and novel holder assembly.

### Background of the Invention

Holder assemblies or containers are typically used to selectively store items, of various kinds, and to allow such stored items to be later retrieved. While such assemblies are known, they have not been employed upon a selectively movable assembly commonly known as a lift.

That is, a lift is used to selectively raise one or more persons off of the ground in order to allow the lifted individual(s) to perform some needed task or function at an elevated location. One non-limiting example of such a task or function involves mechanical types of repair to a pipe or machine which requires tools or other specialized items.

While these lifts do allow individuals to be selectively raised to a desired location in order to allow them to perform some task or function at that location, they do not allow these individuals to quickly retrieve the tools, implements and other items necessary to perform the desired task or function. Oftentimes, such implements must be placed upon the floor or platform and this positioning makes it difficult for the individual(s) to perform the tasks, requiring the individual(s) to bend down and pick up or replace the various implements, causes bodily injury related to the repetitive bending motion, increases the overall length of time necessary to effectuate the repair or other function and thereby increases the overall costs associated with the activity, and also increases the likelihood that the tools or other implements may be dropped or fall off of the raised platform, thereby increasing the likelihood that these “dropped” or fallen implements, tools, or items may strike someone and do injury or become broken or damaged due to such a fall. Even if no injury occurs or no damage occurs to the items, tools, or implements, the lift must often be lowered in order to allow the fallen items, tools, or implements to be retrieved, thereby undesirably interrupting the overall process which is being performed.

The present invention overcomes all of the previously delineated drawbacks and current and prior lifts and provides for secure storage within arid/or upon a lift assembly.

### SUMMARY OF THE INVENTION

It is a first non-limiting object of the present invention to provide a holder which allows items, tools, and/or implements to be selectively and securely stored and later retrieved for use.

It is a second non-limiting object of the present invention to provide a holder which overcomes the various and previously delineated disadvantages of prior holders.

It is a third non-limiting object of the present invention to provide a lift assembly which overcomes the previously delineated disadvantages of prior and current lift assemblies.

It is a fourth non-limiting object of the present invention to provide a lift assembly which includes a holder which allows various items, implements, and tools to be selectively and removably stored for later use.

According to a first non-limiting aspect of the present invention, a holder assembly is provided and includes a container; a body portion which is coupled to the container and which includes two opposed legs, each of the opposed legs including a respective hook portion and a leg portion; and first and second connectors, wherein the first connector is selectively and removably positioned through the leg portion and the hook portion of a first of the two opposed legs and wherein the second connector is selectively and removably positioned through the leg portion and the hook portion of a second of the two opposed legs.

According to a second non-limiting aspect of the present invention, a holder assembly is provided and includes a tray having a flat undersurface and a containment cavity; a body portion which is coupled to the tray and wherein the body portion comprises a pair of opposed legs, wherein each of the opposed legs has a respective elongated portion which terminates into a respective hooked end and wherein each of the respective elongated portions orthogonally project from the containment cavity of the tray and wherein the elongated portions are linearly coextensive and in a parallel arrangement and wherein each of the pair of opposed legs respectively includes respective support arms which are attached to opposed sides of the flat undersurface of the tray , wherein each of the support arms orthogonally and respectively projecting from a unique one of the elongated portions and wherein the support arms are linearly coextensive and parallel to each other and wherein the body portion further comprises a pair of substantially identical first and second angled portions and wherein a first of the substantially identical angled portions is coupled to the elongated portion of the first of the opposed legs and to a first of the support arms and wherein a second of the substantially identical angled portions is coupled to the elongated portion of the second of the opposed legs and to a second of the support arms and wherein the hooked end of first of the pair of opposed legs and the elongated portion of the first of the pair of opposed legs have respective apertures which are aligned and wherein the hooked end of the second of the pair of opposed legs and the elongated portion of the second of the support arms have respective apertures which are aligned and wherein the holder assembly further comprising first and second pin assemblies, wherein the first pin assembly selectively and removably traverses through a first of the pair of aligned apertures and wherein the second pin assembly selectively and removably traverses through a second of the pair of aligned apertures, whereby the first and second pin assemblies selectively allow the holder assembly to be coupled in a desired manner, and wherein the holder assembly further comprises a first and second substantially identical “C”-shaped members which are respectively coupled to the first and second pin assemblies and which respectively secure the first and second pin assemblies within the first and second pair of aligned apertures.

According to a third non-limiting aspect of the present invention, a lift is provided and includes a platform having a floor which is surrounded by a gate having a plurality of parallel rail members; a motorized assembly which is coupled to the platform and which allows the platform to be selectively raised and lowered; and a holder assembly comprising a pair of linearly coextensive and opposed and parallel hooked legs, wherein each of the hooked legs have a respective elongated body portion which abuts the gate and a hook portion which receives one rail member of the gate; a containment tray having a flat undersurface and a containment portion; a pair of substantially identical and linearly coextensive support members which are coupled to the undersurface of the tray; a pair of angled members which are respectively coupled to a unique one of the elongated body portions and to a unique one of the support members; and a quick disconnect assembly which selectively and removably couples said hook portions to said received gate portion.

These and other features, aspects, and advantages of the present invention will become apparent from a reading of the detailed description of the preferred embodiment of the inventions, including the subjoined claims, and by reference to the following drawings.

### BRIEF DESCRIPTION OF THE DRAWINGS

FIG. 1 is a perspective and partial view of a lift assembly which is made in accordance with the teachings of the preferred embodiment of the invention.

FIG. 2 is a perspective view of the holder which is shown in FIG. 1.

FIG. 3 is a front view of the holder which is shown in FIG. 2 and taken in the direction of view arrow “3”.

FIG. 4 is a side view of the holder which is shown in FIG. 1 and taken in the direction of view arrow ‘4”.

FIG. 5 is a back view of the holder which is shown in FIG. 1 and taken in the direction of view arrow “5”.

FIG. 6 is top view of the holder which is shown in FIG. 1 and taken in the direction of view arrow “6”.

FIG. 7 is a bottom view of the holder which is shown in FIG. 1 and taken in the direction of view arrow “7”.

### DETAILED DESCRIPTION OF THE PREFERRED EMBODIMENTS OF THE INVENTION

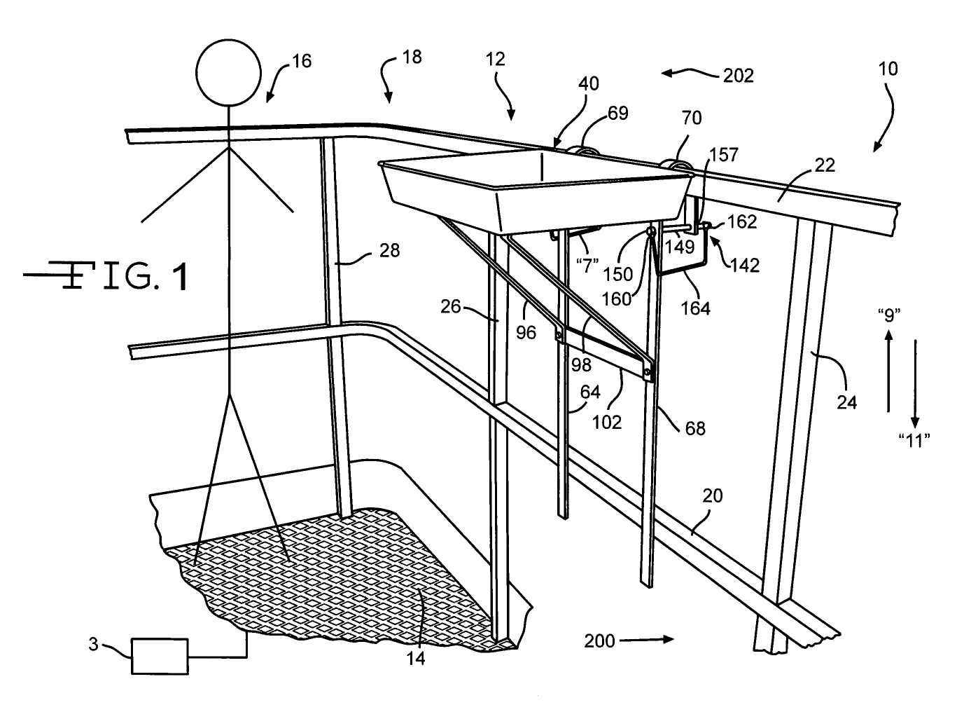

Referring now to FIG. 1, there is shown a lift 10 which is made in accordance with the teachings of the preferred embodiment of the invention and which includes a holder assembly 12 which is adapted to selectively and removably store tools, implements and/or other types of items. As used throughout the remainder of this description, the term “item” means any tangible entity.

As shown, the lift 10 includes a platform 14 upon which one or more users are positioned, such as user 16. Typically surrounding the floor or platform 14 is a gate 18 having at least two parallel rail members 20, 22 which are joined by a plurality of elongated joiner members, such as members 24, 26, 28. Each of the joiner members, such as members 24, 26, 28 orthogonally terminate into or onto the platform 14 and radiate outwardly away from the platform 14, while the members 20, 22 are attached to each of the joiner members, such as members 24, 26, 28 and surround the platform 14 and maintain their parallel relationship. To gain access to the platform 14, a user, such as user 16, may either “hop over” the members 20, 22 or as is more often the case a separate gate is formed by the members 20, 22. Importantly, nothing in this invention or description is meant to limit the use or disposition of the holder assembly 12 to a particular type of lift 10. In fact, holder assembly 12 can be operatively positioned and used within a wide variety of dissimilar lifts having at least two joiner members 20, 22. As will be understood by those of ordinary skill in the art, the platform 14 is selectively moved upwards (in the direction of arrow “9”) and downward (in the direction of arrow “11”) by the use of a hydraulic or other type of actuator assembly 3 which is coupled to the platform 14. As previously indicated, any type of lift assembly may be utilized.

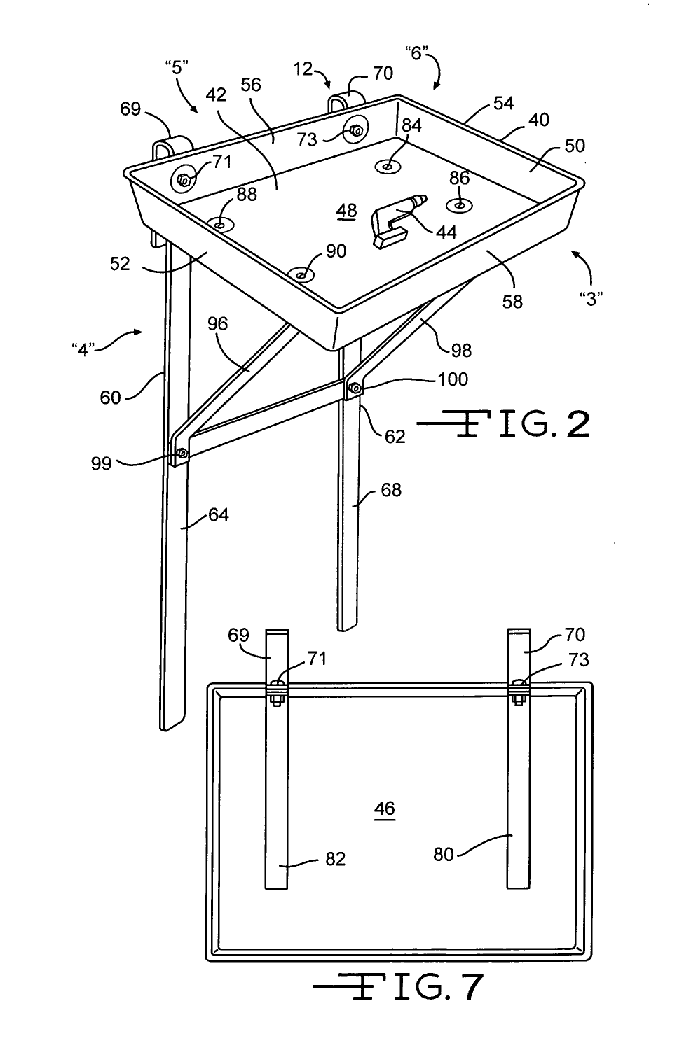

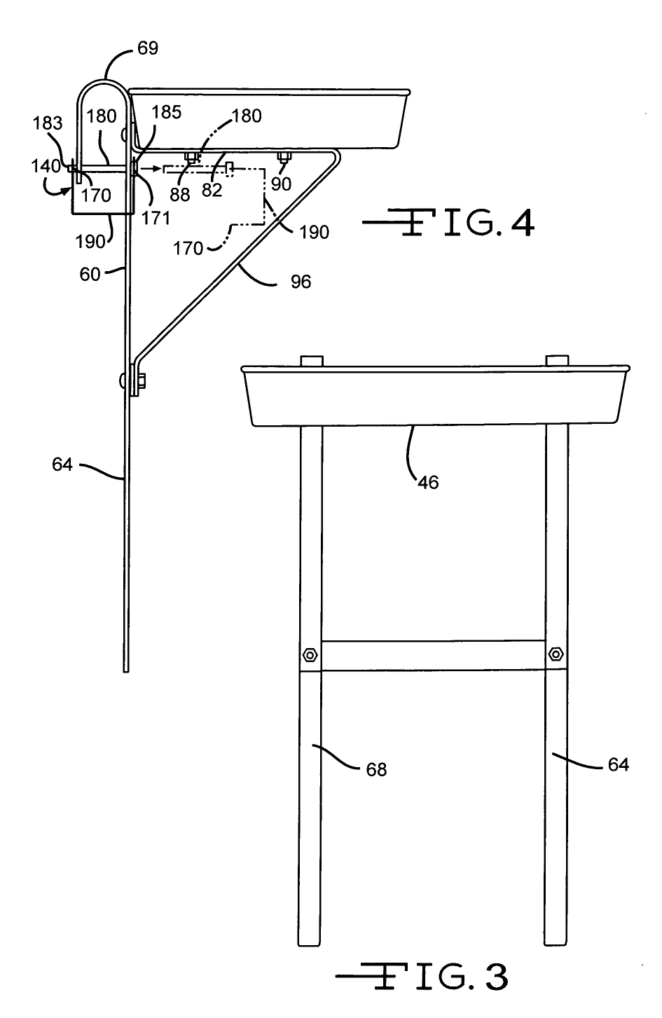

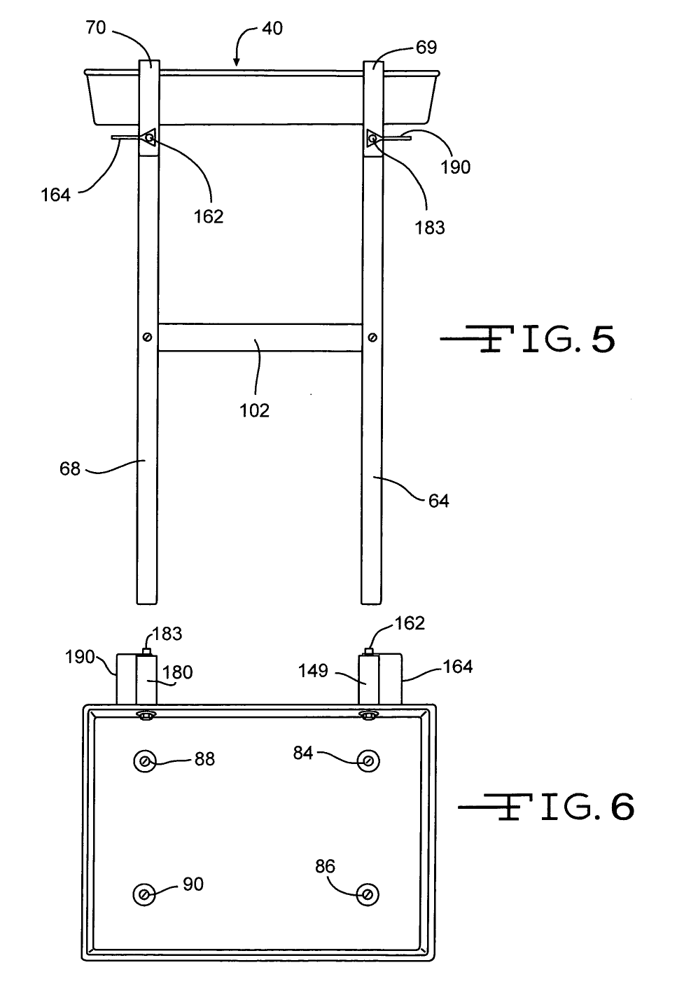

With respect to the holder assembly 12, reference is now made to FIGS. 1-7. That is, as shown, holder assembly 12 includes a tray or containment portion 40 having a containment cavity 42 into which items may be selectively and removably placed, such as item 44 which represents a drill. The portion 40 includes a flat undersurface 46 and the containment cavity 42 is cooperatively formed by a flat upper surface 48 which is surrounded by a generally rectangular shaped perimeter portion 50 which forms or includes sidewall portions 52, 54, back wall portion 56, and front wall portion 58. The perimeter portion 50 terminates into or onto the flat upper surface 48 and protrudes away from the surface 48 in a direction away from the platform 14, thereby reducing the likelihood that stored items, such as item 44, would accidentally “slip” out or fall out of the containment cavity 42.

The holder assembly 12 further includes a pair of substantially identical hook or leg members 60, 62 which each have a respective elongated leg portion 64, 68 which terminates, at one respective end, into a respective hook shaped portion 69, 70. The elongated leg portions 64, 68 are linearly coextensive and are attached to opposed ends of the back wall portion 56 by respective connectors 71, 73. A wide variety of connectors may be used within the holder assembly 14 and term “connector” and “connectors” refers to nuts, bolts, screws, or substantially any other desired and known mechanical connector which joins two mechanical members or tangible items together.

The holder assembly 12 further includes, as best shown in FIGS. 1-7, two substantially identical support members 80, 82 which are respectively attached to opposed ends of the under surface 46 by connector pairs 84,86; and 88,90 and which are linearly coextensive. In one non-limiting embodiment, each member 80, 82 is substantially flat and has a generally rectangular cross sectional area. Further, holder assembly 12 includes two connector or angled members or portions 96, 98, which are substantially identical, linearly coextensive and in one non-limiting embodiment generally flat with a rectangular cross sectional area. Particularly, angled member 96 couples leg portion 64 to member 82 which angled member 98 couples leg portion 68 to support member 80. Connectors 99, 100 are respectively used to connect respective members 96 and 98 to respective portions 64, 68. In the most preferred, although non-limiting embodiment of the invention, angled member 96 and support member 82 are formed by a single “v” shaped member, otherwise member 96 may be coupled to member 82 by a conventional coupling member. Further, in the most preferred, although non-limiting embodiment of the invention, angled member 98 and support member 80 are formed by a single “v” shaped member, otherwise member 98 may be coupled to member 80 by a conventional coupling member. Further, in the most preferred embodiment of the invention, a generally rectangular member 102 may be coupled to leg portions 64, 68 and to the members or portions 96, 98.

As should be apparent to those of ordinary skill in the art, members 98 and 80 on the one hand and members 96 and 82 on the other hand cooperate to secure the tray or containment portion 40 to the respective legs 60,62 and to keep the portion 40 in a substantial orthogonal relationship with the legs 60, 62. The member 102, which may be coupled to the legs 60, 62, by conventional mechanical couplers or connectors, structurally strengthens the connection of portion 40 to the legs 60, 62 and aids in maintaining this orthogonal relationship between the tray or containment portion 40 and the legs 60, 62.

In operation, according to the teachings of one non-limiting embodiment of the invention, the hooks portions 69, 70 respectively receive a gate member 22 while the elongated leg portions 64, 68 abut and engage gate member 20 which lies below (e.g. is positioned closer to the platform 14) the gate member 22. In this manner, the containment portion or tray 14 is horizontally positioned with respect to the platform 14 and lies above the platform 14 and within the confines of the lift 10 (e.g., within the area in which the user 16 is within). The stored items, such as item 44 is therefore very accessible to the user 16 and may be easily obtained from the tray 14 and placed back into the tray or containment area 14 for later user.

In yet another non-limiting embodiment of the invention, the holder assembly 12 also includes a pair of substantially identical stability assemblies 140, 142 which cooperatively reduce the likelihood that the hook portions 69, 70 will become undesirably and/or inadvertently dislodged from their engagement and reception of the gate member 22.

That is, stability assembly 142 includes a pin 149 which traverses a first aperture 151 which is formed within the hook portion 70 and a second aperture 150 which is formed within the leg portion 62 (within elongated portion 68). These two apertures 150, 151 are substantially identical and are aligned within the hook portion 70 receives the gate member 22. The diameter of pin 149 is just smaller than the diameter of the substantially identical apertures 150, 151 and the pin 149 has two opposed ends 160, 162 which respectively protrude out of the respective apertures 150, 151. The assembly 142 includes a flexible but firm wire or other type of member 164 which is coupled to the ends 160, 162. Such coupling may be by means of a knot formed at each end 160, 162 by member 164. Member 164 may also form a plastic clip 164 which is glued to ends 160, 162, or “press fit” on ends 160, 162.

In operation, the pin 149 may be forcibly dislodged from its position within and through the aligned apertures 150, 151 when it is desired to disengage or remove the holder 12 from its operative position upon the gate member 22. When the holder 14 is in its operative position, as shown for example in FIG. 1, then the deployed pin 149 acts to maintain the reception of the gate member 22 within the hook portion 70 and the wire or flexible member 164 increases the amount of force needed to “pull” the pin 149 out of the apertures 150, 151 thereby reducing the likelihood that the pin 149 would be pulled out of the apertures 150, 151 by some movement of lift 10 or some other incidental and/or unexpected force. Thus, the firm member 164 keeps the pin 149 in the operative position shown, for example in FIG. 1, and this pin 149 functions to keep the hook portion 70 upon the gate member 22 and thus functions to keep the holder 12 connected to the lift 10.

Similarly, apertures 170, 171 are respectively formed within hook portion 69 and leg member 60 and these apertures 170, 171 are aligned within hook portion 69 receives gate member 22. A pin 180, which may be substantially identical to pin 149 (and apertures 170, 171 may also be substantially identical to apertures 150, 151) may be made to traverse and extend out of the aligned apertures 170, 171. That is, end 183 of pin 180 may extend out of aperture 183 and end 185 of pin 180 may extend out of aperture 185. The diameter of pin 180 is slightly smaller than the diameter of the substantially identical and aligned apertures 183, 185. Further, a flexible but firm wire or member 190 (which may be substantially similar to member or wire 164) may be coupled to opposed ends 183, 185 and this flexible but firm member 190 increases the amount of force necessary to “pull” the on 180 out of its position within and through the aligned apertures 183, 185 and the pin 180 functions to keep the gate member 22 within the hook portion 69 and the holder assembly 12 connected to the lift assembly 10. The wire or flexible member 190 thereby reduces the likelihood that the hook portion 69 will be undesirably and inadvertently disengaged from its coupling to the gate member 22. The coupling of member 190 may be achieved by forming knots, with member 190, at each end 183, 185. Member 190 may be a plastic clip which may be glued on ends 183, 185 or press fit on to ends 183, 185.

In the most preferred, although not the only, embodiment of the invention, the flexible but firm members 164 and 190 are generally “C” shaped and break away from their respective pins 149, 180 when their respective pins 149, 180 are moved out of their respective pairs of aligned apertures. Members 164, 190 may be connected by member 250 and as member 250 is pulled, the member 164, 190 may be simultaneously pulled away from respective members 149, 180 to facilitate a quick removal of tray 12 from the lift 10.

Further, in the most preferred embodiment of the invention, the leg portions 64, 68 are made to about gate member 20 and move in direction 200 toward the gate member 20. The hook portions 69, 70 move in direction 202 which is opposite to direction 200 and these two opposed directional movements of the top (tray portion 14) and the bottom (leg portions 64, 68) of the holder assembly 12 cooperatively maintain the holder assembly 12 connected to the gate member 22 and to the lift 10 and maintain the horizontal placement of the containment portion 12 with respect to the platform 14.

It is understood that the present inventions are not limited to the exact construction or methodology or embodiments which have been delineated above, but that various changes and modifications may be made without departing from the spirit and scope of the inventions as they are more fully delineated in the following claims.

What is claimed is:

1) A holder assembly comprising a container; a body portion which is coupled to said container and which includes two opposed legs, each of said opposed legs including a respective hook portion and a leg portion; and first and second connectors, wherein said first connector is selectively and removably positioned through said leg portion and said hook portion of a first of said two opposed legs and wherein said second connector is selectively and removably positioned through said leg portion and said hook portion of a second of said two opposed legs.

2) A holder assembly comprising a tray having a flat undersurface and a containment cavity; a body portion which is coupled to said tray and wherein said body portion comprises a pair of opposed legs, wherein each of said opposed legs has a respective elongated portion which terminates into a respective hooked end and wherein each of said respective elongated portions orthogonally project from said containment cavity of said tray and wherein said elongated portions are linearly coextensive and in a parallel arrangement and wherein each of said pair of opposed legs respectively includes respective support arms which are attached to opposed sides of said flat undersurface of said tray, wherein each of said support arms orthogonally and respectively projecting from a unique one of said elongated portions and wherein said support arms are linearly coextensive and parallel to each other and wherein said body portion further comprises a pair of substantially identical first and second angled portions and wherein a first of said substantially identical angled portions is coupled to said elongated portion of said first of said opposed legs and to a first of said support arms and wherein a second of said substantially identical angled portions is coupled to said elongated portion of said second of said opposed legs and to a second of said support arms and wherein said hooked end of first of said pair of opposed legs and said elongated portion of said first of said pair of opposed legs have respective apertures which are aligned and wherein said hooked end of said second of said pair of opposed legs and said elongated portion of said second of said support arms have respective apertures which are aligned and wherein said holder assembly further comprising first and second pin assemblies, wherein said first pin assembly selectively and removably traverses through a first of the pair of aligned apertures and wherein said second pin assembly selectively and removably traverses through a second of the pair of aligned apertures, whereby said first and second pin assemblies selectively allow said holder assembly to be coupled in a desired manner, and wherein said holder assembly further comprises a first and second substantially identical “C”-shaped members which are respectively coupled to said first and second pin assemblies and which respectively secure said first and second pin assemblies within said first and second pair of aligned apertures.

3) A lift comprising a platform having a floor which is surrounded by a gate having a plurality of parallel rail members; a motorized assembly which is coupled to said platform and which allows said platform to be selectively raised and lowered; and a holder assembly comprising a pair of linearly coextensive and opposed and parallel hooked legs, wherein each of said hooked legs have a respective elongated body portion which abuts said gate and a hook portion which receives one rail member of said gate; a containment tray having a flat undersurface and a containment portion; a pair of substantially identical and linearly coextensive support members which are coupled to said undersurface of said tray; a pair of angled members which are respectively coupled to a unique one of said elongated body portions and to a unique one of said support members; and a quick disconnect assembly which selectively and removably couples said hook portions to said received gate member.
